(19) United States
(12) Patent Application Publication
(10) Pub. No.: US 2004/0006818 A1
(43) Pub. Date: Jan. 15, 2004

(54) Pulsating-spray shower head

(75) Inventors: Eckhard Gransow, Frondenberg (DE); Hans Lobermeier, Menden (DE); Bernd Bischoff, Hemer (DE); Hans-Peter Strelow, Freiburg (DE); Sascha Korfer, Hemer (DE); Holger Ellerbrock, Munster (DE); Andreas Kirchhoff, Wickede (DE); Thomas Raadts, Frondenberg (DE); Joachim Stork, Kippenheim (DE); Hans-Jurgen Linde, Coburg (DE); Uwe Neumann, Bamberg (DE); Andreas Rehklau, Coburg (DE)

Correspondence Address: THE FIRM OF KARL F ROSS, 5676 RIVERDALE AVENUE, PO BOX 900, RIVERDALE (BRONX), NY, 10471-0900, US

(73) Assignee: Friedrich Grohe AG & Co. KG

(21) Appl. No.: 10/465,735

(22) Filed: Jun. 19, 2003

(30) Foreign Application Priority Data
Jul. 11, 2002 (DE) 10231575.2

(51) Int. Cl. A47K 3/28; B05B 1/26

(52) U.S. Cl. 4/615; 239/461

(57) ABSTRACT

A shower head has a body having an inlet adapted to be connected to a source of pressurized water and an opposite end face formed with a plurality of arrays of spray openings. Respective sprayers in the body at the spray-opening arrays periodically block and unblock same and thereby cause pulsating streams of the water to issue therefrom.

### FIELD OF THE INVENTION

The present invention relates to a shower head. More particularly this invention concerns a shower head that produces a pulsating spray.

### BACKGROUND OF THE INVENTION

A pulsating-spray shower head is known from German patent document 4,031,206 of H. Korfgen. It has a housing centered on an axis and formed on one side with an inlet fitting adapted to be connected to a supply of pressurized water and on an opposite side with a circular array of spray openings centered on the axis. Internally a partition subdivides the housing into an inlet compartment into which the inlet fitting opens and an outlet compartment into which the spray openings open. The outlet compartment is formed at the spray openings with an annular track in which rides a ball that can travel angularly around the outlet compartment, blocking and unblocking the spray openings as it passes over them. The partition is formed centered on the axis with an annular array of angled passages so that water from the inlet compartment is ejected into the outlet compartment to create a rotating toroidal flow therein that sweeps the ball around in the track, blocking and then unblocking the spray openings as it passes over them, with the flow issuing from the outlet compartment as individual streams from the spray openings. The result is a pulsating spray since the spray openings are periodically blocked and unblocked, stopping and starting the streams emitted by them.

The pulsation of such a system is fairly weak, as at any given time at most one of the spray openings is blocked. Hence the massage effect is modest at best.

### OBJECTS OF THE INVENTION

It is therefore an object of the present invention to provide an improved pulsating-spray shower head.

Another object is the provision of such an improved pulsating-spray shower head which overcomes the above-given disadvantages, that is which produces a particularly vigorous and strong pulsating spray.

### SUMMARY OF THE INVENTION

A shower head has according to the invention a body having an inlet adapted to be connected to a source of pressurized water and an opposite end face formed with a plurality of arrays of spray openings. Respective sprayers in the body at the spray-opening arrays periodically block and unblock same and thereby cause pulsating streams of the water to issue therefrom.

Such a shower head, which can have three or five such arrays, produces a particularly vigorous and effective massage spray. The multipart spray covers a much larger area, and pulsates over its entire area so that it is extremely vigorous and effective.

The body is centered on an axis and the arrays and sprayers are angularly equispaced about and/or symmetrical to the axis. Each of the sprayers includes a respective annular track extending over the respective spray openings, one or more movable elements riding in the track and capable of traveling therearound while periodically blocking the respective spray openings, and means for feeding the water from the inlet to the sprayers to orbit the respective elements around the tracks and thereby periodically block the respective spray openings. The element can be a ball or other object capable of being pushed around the track by the water circulating therein. Each sprayer has five spray openings and the body is unitarily formed with the inlet.

### BRIEF DESCRIPTION OF THE DRAWING

The above and other objects, features, and advantages will become more readily apparent from the following description, it being understood that any feature described with reference to one embodiment of the invention can be used where possible with any other embodiment and that reference numerals or letters not specifically mentioned with reference to one figure but identical to those of another refer to structure that is functionally if not structurally identical. In the accompanying drawing:

FIG. 1 is an axial section through a spray head according to the invention;

FIG. 2 is an end view of the spray head of FIG. 1, line I-I being the section plane for FIG. 1;

FIG. 3 is an axial section through another spray head in accordance with the invention; and

FIG. 4 is an end view of the spray head of FIG. 3, line III-III being the section plane for FIG. 3.

### SPECIFIC DESCRIPTION

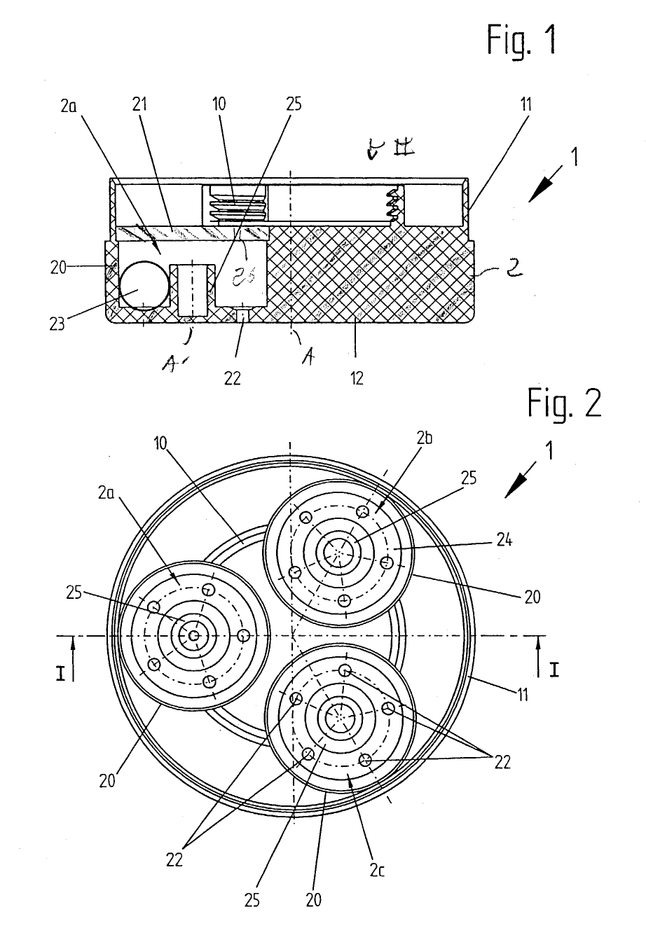

As seen in FIGS. 1 and 2, a shower-head subassembly 1 according to the invention has a molded-plastic body 2 centered on an axis A and formed with a rearwardly projecting and internally threaded inlet collar 10 by means of which it is secured to an unillustrated shower-head back that fits via an O-ring with an external cylindrical surface 11 of the body 2. This allows the entire rear of the body 2 to be exposed to water under pressure.

A front side of the body 2 is formed with a plurality of identical sprayers 2a, 2b, and 2c angularly equispaced about the axis A. Each such sprayer 2a, 2b, and 2c has a respective circular array of spray or nozzle openings 22 opening at an end face 12 and is internally formed with an annular part circular-section track groove 24 in which rides a ball 23. Respective tubular centering posts 25 insure that the balls 23 can orbit around the respective axes A′ of their sprayers 2a, 2b, or 2c, momentarily blocking and closing the respective openings 22 as it passes them. Respective rear wall plates 21 (shown in detail in FIGS. 5 and 6 but not shown in FIG. 2) formed with angled openings 26 are provided at the rear sides of the sprayers 2a, 2b, and 2c and receive pressurized water from a hose or pipe threaded into the inlet 10.

Thus, when the inlet 10 is pressurized, the sprayers 2a, 2b, and 2c will each fill with a toroidal body of water that moves angularly about the respective axis A′ and that exits through the respective openings 22. The angular movement of the water in the sprayers 2a, 2b, and 2c sets the balls 23 to orbiting and periodically blocks and unblocks the respective openings 22, thereby creating pulsating streams issuing from the holes 22. The pulsation frequency is generally proportional to water pressure so that with higher pressurization, a more intense and rapidly pulsing flow is created.

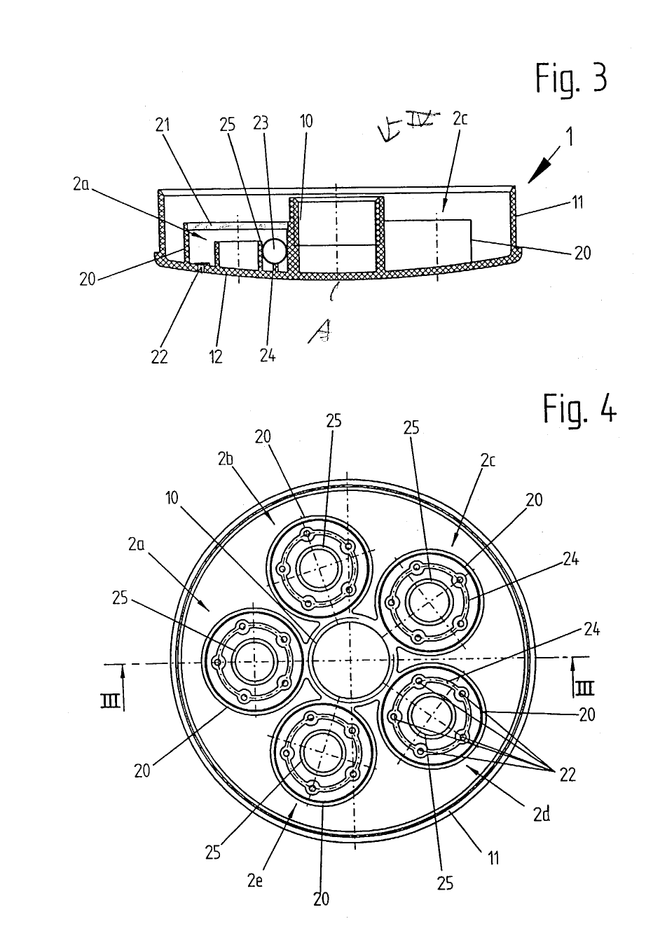

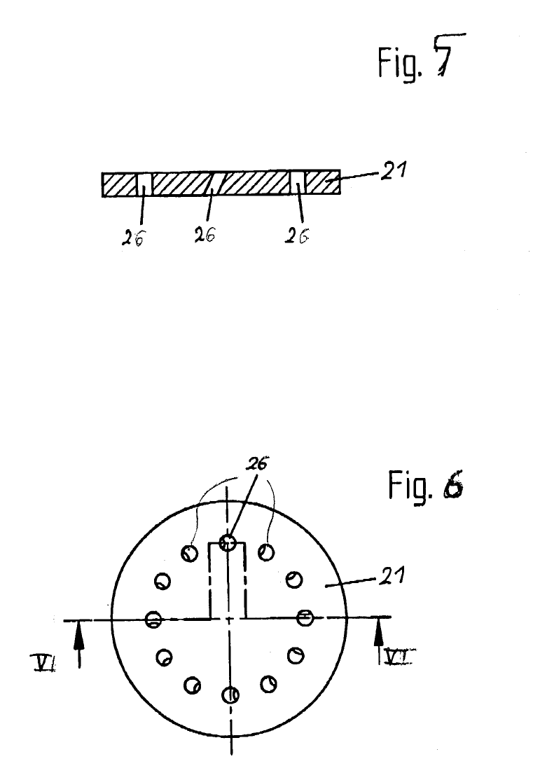

FIGS. 3 and 4 show a similar arrangement, but with five sprayers 2a, 2b, 2c, 2d, and 2e angularly equispaced about the axis A. The end wall 12 is unitary with the body 2 in both embodiments.

We claim:

1. A shower head comprising:
a body having an inlet adapted to be connected to a source of pressurized water and an opposite end face formed with a plurality of arrays of spray openings; and
respective spray means in the body at the spray-opening arrays for periodically blocking and unblocking same and thereby causing pulsating streams of the water to issue therefrom.

2. The shower head defined in claim 1 wherein there are three such arrays and spray means.

3. The shower head defined in claim 1 wherein there are five such arrays and spray means.

4. The shower head defined in claim 1 wherein the body is centered on an axis and the arrays and spray means are angularly equispaced about the axis.

5. The shower head defined in claim 1 wherein each spray means includes
a respective annular track extending over the respective spray openings;
a movable element riding in the track and capable of traveling therearound while periodically blocking the respective spray openings; and
means for feeding the water from the inlet to the sprayers to orbit the respective elements around the tracks and thereby periodically block the respective spray openings.

6. The shower head defined in claim 5 wherein the elements are balls.

7. The shower head defined in claim 1 wherein each sprayer has five spray openings.

8. The shower head defined in claim 1 wherein the body is unitarily formed with the inlet.

9. A shower head comprising:
a body centered on an axis and having a rearwardly open inlet adapted to be connected to a source of pressurized water and an opposite end face formed with a plurality of arrays of spray openings; and
respective sprayers in the body at the spray-opening arrays each comprising
a respective annular track extending over the respective spray openings;
a movable element riding in the track and capable of traveling therearound while periodically blocking the respective spray openings; and
means for feeding the water from the inlet to the sprayers to orbit the respective elements around the tracks and thereby periodically block the respective spray openings.
